(19) United States
(12) Patent Application Publication
(10) Pub. No.: US 2025/0385381 A1
(43) Pub. Date: Dec. 18, 2025

(54) POWER STORAGE DEVICE

(71) Applicant: Toyota Jidosha Kabushiki Kaisha, Toyota-cho (JP)

(72) Inventors: Akio UOTANI, Nagoya-shi (JP); Dexu Zhang, Mishima-shi (JP); Yoshinobu Kuroyama, Aichi-gun (JP); Daisuke Kamesaki, Okazaki-shi (JP); Seigo Fujishima, Miyoshi-shi (JP); Yuki Takahashi, Miyoshi-shi (JP)

(73) Assignee: Toyota Jidosha Kabushiki Kaisha, Toyota-cho (JP)

(21) Appl. No.: 19/044,000

(22) Filed: Feb. 3, 2025

(30) Foreign Application Priority Data
Jun. 13, 2024 (JP) 2024-095840

(51) Int. Cl. H01M 50/342

(52) U.S. Cl. CPC H01M 50/3425; H01M 2220/20

(57) ABSTRACT

The power storage device includes one or more power storage stacks, and includes a power storage module having a total positive terminal and a total negative terminal, a housing case for housing the power storage module, a case-side exhaust valve provided in the housing case, and a first connector electrically connected to the total positive terminal and a second connector electrically connected to the total negative terminal, wherein the housing case has a first wall portion and a second wall portion opposed to each other in the first direction, the first connector and the second connector are provided in the first wall portion, the case-side exhaust valve is provided in the second wall portion, and each of the one or more power storage stacks is provided so as to be capable of discharging gas in a second direction orthogonal to the first direction.

### CROSS-REFERENCE TO RELATED APPLICATION

This application claims priority to Japanese Patent Application No. 2024-095840 filed on Jun. 13, 2024, incorporated herein by reference in its entirety.

### BACKGROUND

### 1. Technical Field

The present disclosure relates to a power storage device.

### 2. Description of Related Art

As a related-art power storage device, WO2020/134054 discloses a configuration in which a plurality of power storage stacks is arranged in a predetermined direction.

### SUMMARY

The power storage stacks are electrically connected in series, and the power storage device includes a total positive terminal and a total negative terminal of a total potential of the power storage stacks. In general, a first connector electrically connected to the total positive terminal and a second connector electrically connected to the total negative terminal are provided on the same wall portion of a housing case.

If there is no measure, when gas is discharged from any power storage stack, debris contained in the gas causes a short circuit by electrical connection between the first connector and the second connector, or a short circuit by electrical connection between a portion routed in the vicinity of the first connector in an electrical path from the total positive terminal to the first connector and a portion routed in the vicinity of the second connector in an electrical path from the total negative terminal to the second connector. That is, the total negative terminal and the total positive terminal may be short-circuited via the first connector and the second connector and/or the electrical paths. In such a case, there is a concern that the power storage stacks constituting a power storage module generate heat as a whole.

The present disclosure has been made in view of the above problems, and an object of the present disclosure is to provide a power storage device capable of suppressing a short circuit between a total positive terminal and a total negative terminal.

A power storage device according to the present disclosure includes:
a power storage module including one or more power storage stacks and including a total positive terminal and a total negative terminal;
a housing case that houses the power storage module;
a case-side exhaust valve provided in the housing case; and
a first connector electrically connected to the total positive terminal and a second connector electrically connected to the total negative terminal.
The housing case includes a first wall portion and a second wall portion facing each other in a first direction.
The first connector and the second connector are provided on the first wall portion. The case-side exhaust valve is provided on the second wall portion.
The one or more power storage stacks are each provided to discharge gas in a second direction orthogonal to the first direction.

In the above configuration, the case-side exhaust valve is provided opposite, in the first direction, to the side where the first connector and the second connector are located, and the gas is discharged from the power storage stack in the second direction orthogonal to the first direction. Therefore, it is possible to reduce the occurrence of a case where the gas discharged from the power storage stack is directed toward the first connector and the second connector. Thus, it is possible to reduce the occurrence of a case where the gas causes a short circuit between the first connector and the second connector, or a short circuit between a portion routed in the vicinity of the first connector in an electrical path from the total positive terminal to the first connector and a portion routed in the vicinity of the second connector in an electrical path from the total negative terminal to the second connector. As a result, a short circuit between the total positive terminal and the total negative terminal can be suppressed.

In the power storage device according to the present disclosure,
the gas discharged from any of the one or more power storage stacks may be discharged from the case-side exhaust valve through a space in the housing case.

In the above configuration, the space in the housing case can be used as an exhaust path for the gas. Therefore, the configuration of the housing case can be simplified.

In the power storage device according to the present disclosure,
the housing case may include a third wall portion and a fourth wall portion each connecting two ends of the first wall portion and the second wall portion in the second direction.
In this case, at least either of the third wall portion and the fourth wall portion may be provided with an inlet into which the gas is introduced, and a flow path connecting the inlet and the case-side exhaust valve.

In the above configuration, the exhaust path is provided in the outer wall portion of the housing case. Therefore, accumulation of debris contained in the gas in the housing space of the housing case can be suppressed, and a short circuit in the power storage stack due to the debris can be suppressed.

According to the present disclosure, it is possible to provide the power storage device capable of suppressing the short circuit between the total positive terminal and the total negative terminal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a vehicle equipped with a power storage device according to a first embodiment;

FIG. 2 is a diagram illustrating a state in which the power storage device according to the first embodiment is fixed to a vehicle body;

FIG. 3 is an exploded perspective view of a power storage device according to Embodiment 1;

FIG. 4 is a diagram for explaining a flow of gas discharged from a power storage stack in the power storage device according to the first embodiment;

FIG. 5 is a diagram for explaining a flow of gases discharged from a power storage stack in the power storage device according to the second embodiment; and

FIG. 6 is a cross-sectional view of a power storage device according to Embodiment 3.

### DETAILED DESCRIPTION OF EMBODIMENTS

Hereinafter, embodiments of the present disclosure will be described in detail with reference to the drawings. In the following embodiments, the same or common parts are denoted by the same reference numerals in the drawings, and the description thereof will not be repeated.

### First Embodiment

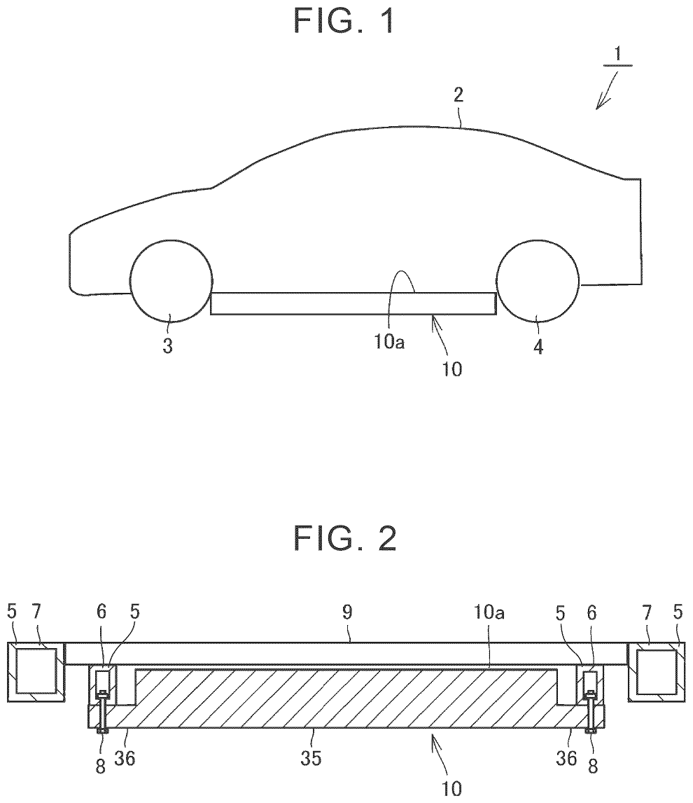

FIG. 1 is a schematic diagram illustrating a vehicle according to a first embodiment. FIG. 2 is a diagram illustrating a state in which the power storage device according to the first embodiment is fixed to a vehicle body. Referring to FIGS. 1 and 2, a vehicle 1 according to an embodiment will be described.

The vehicle 1 is a hybrid electric vehicle that can travel by using power of at least one of a motor and an engine, or an electrified vehicle that travels by a driving force obtained by electric energy.

The vehicle 1 includes a vehicle body 2, a front wheel 3, a rear wheel 4, and a power storage device 10. The vehicle body 2 includes a frame member 5. The power storage device 10 is disposed below the vehicle body 2. The power storage device 10 is disposed, for example, between the front wheel 3 and the rear wheel 4. Note that a part of the power storage device 10 may be disposed so as to overlap at least one of the front wheel 3 and the rear wheel 4 when viewed from the width direction of the vehicle 1. The power storage device 10 has an upper surface 10a. The upper surface 10a may function as a floor member defining the interior of the vehicle.

The frame member 5 includes a pair of side members 6 and a pair of side sills 7. The pair of side sills 7 are disposed on both end sides in the width direction of the vehicle 1. The pair of side members 6 are disposed inside the pair of side sills 7 at a distance. The pair of side members 6 and the pair of side sills 7 extend along the front-rear direction of the vehicle 1.

The pair of side members 6 are spaced apart in the width direction of the vehicle 1. A main body portion 35 of the power storage device 10 is disposed in a gap between the pair of side members 6. A gap is provided between the main body portion 35 and the pair of side members 6. Thus, even when the vehicle 1 collides laterally, it is possible to prevent an impact from being input to the power storage device 10.

The fixed portions 36 are provided on both side surfaces of the main body portion 35 in the width direction of the vehicle 1. The fixed portion 36 is fixed to the pair of side members 6 by the fastening member 8.

The frame member 5 also includes a cross frame member 9. The cross frame member 9 is provided so as to straddle the other side sill 7 from the one side sill 7 above the power storage device 10. An upper surface 10a of the power storage device 10 is fixed to the cross frame member 9.

In the above description, a case in which the frame member 5 includes the pair of side members 6 and the pair of side sills 7 has been described as an example, but the present disclosure is not limited thereto. The pair of side sills 7 may also have the function of the pair of side members 6. In this case, the pair of side members 6 may be omitted, and the fixed portion 36 may be fixed to the pair of side sills 7.

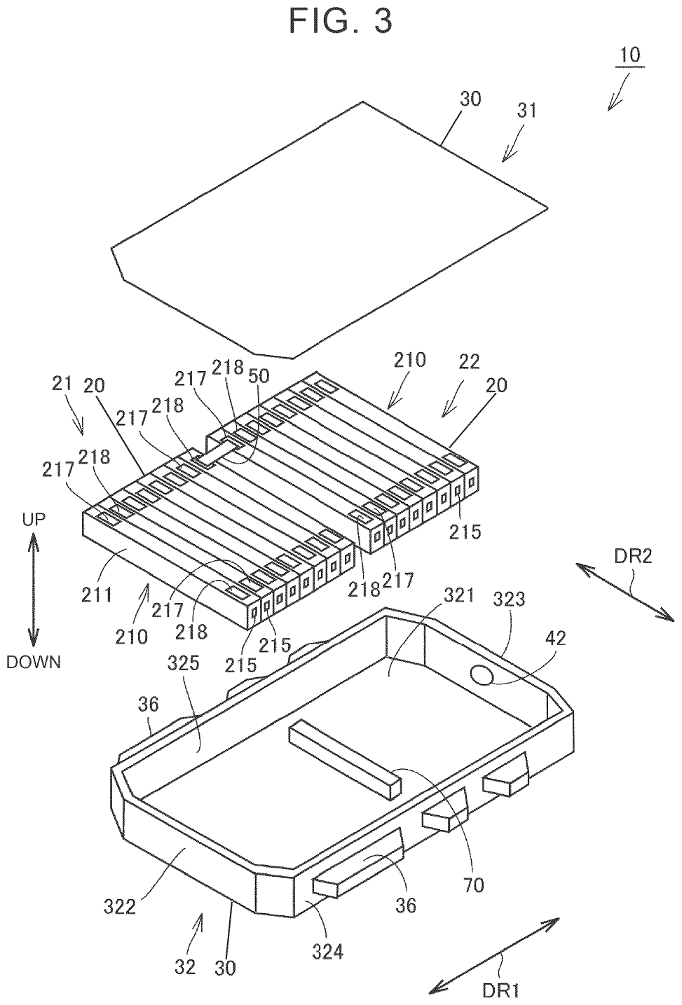

FIG. 3 is an exploded perspective view of a power storage device according to Embodiment 1. The power storage device 10 according to the first embodiment will be described with reference to FIG. 3.

As illustrated in FIG. 3, the power storage device 10 includes a power storage module 20, a housing case 30, a case-side exhaust valve 42, an electrical connection member 50, and a cross member 70. 20

The power storage module 20 includes a first power storage stack 21 and a second power storage stack 22. The first power storage stack 21 and the second power storage stack 22 are arranged in the first direction (DR1 direction). The first direction is, for example, parallel to the front-rear direction of the vehicle 1.

Each of the first power storage stack 21 and the second power storage stack includes a plurality of unit cells 210. The plurality of unit cells 210 are arranged in the first direction. More specifically, the plurality of unit cells 210 are arranged in the first direction in a state in which an exhaust valve 215, which will be described later, is positioned on one side in the second direction.

The unit cell 210 has a longitudinal shape in which a second direction orthogonal to the first direction is a longitudinal direction. The unit cell 210 has a flat rectangular parallelepiped shape having a thickness in the first direction.

Each of the plurality of unit cells 210 includes a housing 211, an exhaust valve 215, a positive electrode external terminal 217, and a negative electrode external terminal 218.

The housing 211 has a pair of side wall portions that face each other in the longitudinal direction. The exhaust valve 215 is provided on one side wall of the pair of side wall portions. The exhaust valve 215 is a valve for discharging gas from the unit cell 210 when the pressure in the unit cell 210 becomes higher than a predetermined pressure. The exhaust valve 215 may be provided on the other side wall portion of the pair of side wall portions, or may be provided on both of the pair of side wall portions.

The positive electrode external terminal 217 and the negative electrode external terminal 218 are provided, for example, in an upper wall portion of the housing 211, 221. The positive electrode external terminal 217 and the negative electrode external terminal 218 may be provided in the side wall portion of the housing 211 in the longitudinal direction.

One or a plurality of electrode bodies 25 are accommodated in the housing 211. When a single electrode body 25 is accommodated, the electrode body 25 has a shape extending in the longitudinal direction. The electrode body 25 may be a laminated electrode body in which a negative electrode sheet, a separator, and a positive electrode sheet are laminated, or may be a wound electrode body in which a negative electrode sheet, a separator, and a positive electrode sheet are wound.

When the plurality of electrode bodies 25 are accommodated, the plurality of electrode bodies 25 are arranged side by side in the longitudinal direction and are connected in series. Also in this case, the electrode body 25 may be a laminated electrode body or a wound electrode body.

The unit cell 210 is a secondary battery such as a nickel metal hydride battery or a lithium-ion battery. The unit cell 210 may be a liquid electrolyte or a solid electrolyte. The unit cell 210 may be a chargeable/dischargeable capacitor.

The housing case 30 includes an upper member 31 and a lower member 32 as a lower case. The lower member 32 has a substantially box-shaped shape that opens upward. The lower member 32 includes a main body portion 35 and a fixed portion 36.

The main body portion 35 includes a bottom wall portion 321, a first wall portion 322, a second wall portion 323, and a pair of side wall portions 324, 325. The first wall portion 322, the second wall portion 323, and the pair of side wall portions 324, 325 are provided so as to stand up from the peripheral edge of the bottom wall portion 321.

The first wall portion 322 and the second wall portion 323 face each other in the first direction. The first wall portion 322 is located on one side in the first direction. The second wall portion 323 is located on the other side in the first direction. The pair of side wall portions 324, 325 oppose each other in the second direction. The side wall portion 324 is a third wall portion and is located on one side in the second direction. The side wall portion 325 is a fourth wall portion and is located on the other side in the second direction.

The side wall portion 324 connects end portions of the first wall portion 322 and the second wall portion 323 located on one side in the second direction. The side wall portion 325 connects end portions of the first wall portion 322 and the second wall portion 323 located on the other side in the second direction.

The fixed portion 36 is provided on an outer surface of the pair of side wall portions 324, 325. The fixed portion 36 is provided so as to extend intermittently in the first direction. A portion of the fixed portion 36 located on the most one side in the first direction is longer in length in the first direction than the other portions.

The upper member 31 has a substantially plate-like shape. The upper member 31 closes the opening of the lower member 32. The shape of the upper member is not limited to a plate shape, and may be a substantially box shape that opens downward. The upper member 31 has a top plate portion facing the bottom wall portion 321 in the up-down direction.

The case-side exhaust valve 42 is provided in the housing case. Specifically, it is provided in the second wall portion 323. The case-side exhaust valve 42 is a pressure release valve that is opened when the pressure in the housing case 30 becomes higher than a predetermined pressure. When the pressure in the housing case 30 becomes higher than a predetermined pressure due to the gas discharged from the first power storage stack 21 or the second power storage stack 22, the case-side exhaust valve 42 is opened and the gas is discharged to the outside of the housing case 30.

The electrical connection member 50 electrically connects the first power storage stack 21 and the second power storage stack 22. The electrical connection member 50 is constituted by, for example, a conductive member such as a bus bar. The electrical connection member 50 is disposed so as to straddle the cross member 70. Thus, interference between the electrical connection member 50 and the cross member 70 can be suppressed.

The cross member 70 is disposed between the first power storage stack 21 and the second power storage stack 22 in the housing case 30. The cross member 70 extends along a direction intersecting the arrangement direction in which the first power storage stack 21 and the second power storage stack 22 are arranged. Specifically, the cross member 70 extends along the second direction orthogonal to the first direction. A gap is formed between the cross member 70 and the upper member 31.

In the present embodiment, a gap is provided between the cross member 70 and the pair of side wall portions 324, 325. The accommodation space located on one side of the cross member 70 in the first direction and in which the first power storage stack 21 is disposed, and the accommodation space located on the other side of the cross member 70 in the first direction and in which the second power storage stack 22 is disposed are connected to each other via the gap.

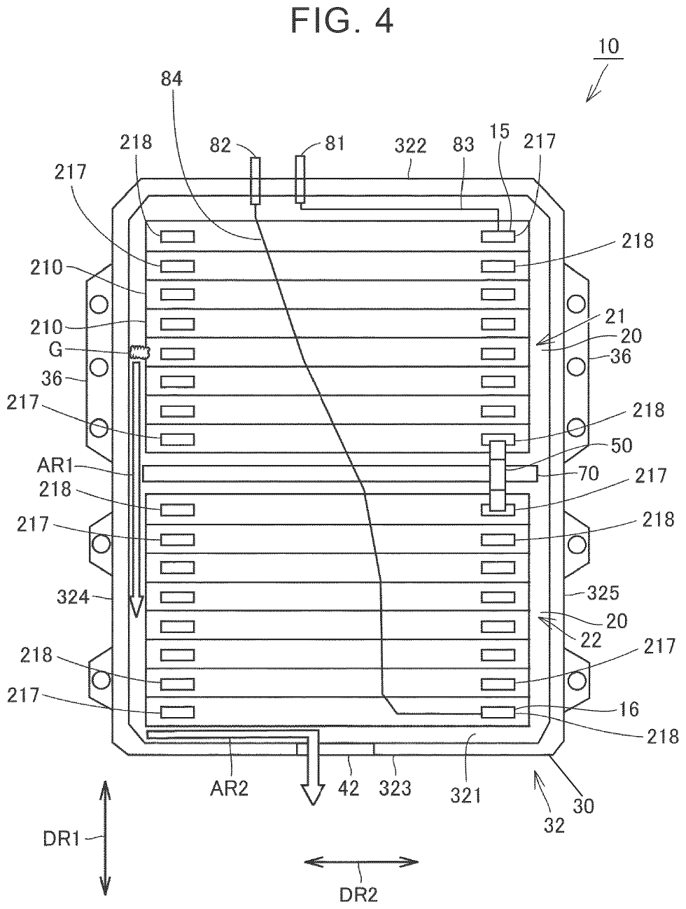

FIG. 4 is a diagram for explaining a flow of gas discharged from a power storage stack in the power storage device according to the first embodiment.

As illustrated in FIG. 4, the power storage device 10 includes a first connector 81, a second connector 82, and wires 83 and 84. The first connector 81 and the second connector 82 are provided in the first wall portion 322. The first connector 81 and the second connector 82 are arranged side by side in the second direction.

The power storage module 20 includes a total positive terminal 15 and a total negative terminal 16 of the total potential. The total positive terminal 15 is constituted by, for example, the positive electrode external terminal 217 of the unit cell 210 located on the one-most side in the first direction in the first power storage stack 21. The total negative terminal 16 is constituted by, for example, the negative electrode external terminal 218 of the unit cell 210 located on the other side of the second power storage stack 22 in the first direction.

The first connector 81 is connected to the total positive terminal 15 by a wire 83. The second connector 82 is connected to the total negative terminal 16 by a wire 84.

Each of the first power storage stack 21 and the second power storage stack 22 is provided so as to be capable of discharging gas in the second direction. Specifically, in each of the first power storage stack 21 and the second power storage stack 22, the exhaust valve 215 is disposed so as to be positioned on one side in the second direction as described above.

For example, when the gas G is discharged from any one of the unit cells 210 of the first power storage stack 21, the gas G is discharged in a second direction orthogonal to the first direction. Specifically, the gas G is discharged toward a space between the side wall portion 324 and the first power storage stack 21. When the pressure in the accommodation space reaches a predetermined value and the case-side exhaust valve 42 is opened, the gas G moves in the first direction toward the side opposite to the side where the first connector 81 and the second connector 82 are located, as indicated by the arrow AR1. When the pressure in the volume reaches a predetermined value and the case-side exhaust valve 42 is opened, the gas G is discharged to the outside from the case-side exhaust valve 42 as indicated by an arrow AR2.

When the gas is discharged from any of the unit cells 210 of the second power storage stack 22, the gas flows similarly to the case where the gas is discharged from the first power storage stack 21.

As described above, in the power storage device 10 according to the present embodiment, it is possible to prevent the gas discharged from the first power storage stack 21 or the second power storage stack 22 from being directed toward the first connector 81 and the second connector 82. Thus, debris such as metal foreign matter contained in the gas, the first connector 81 and the second connector 82 is electrically connected, it is possible to suppress the total positive terminal 15 and the total negative terminal 16 through the wire 83, 84 is short-circuited.

Similarly, a portion of the wire 83 that is routed in the vicinity of the first connector 81 (specifically, a portion of the wire 83 that is located between the first wall portion 322 and the first power storage stack 21) and a portion of the wire 84 that is routed in the vicinity of the second connector 82 (specifically, a portion of the wire 84 that is located between the first wall portion 322 and the first power storage stack 21) are electrically connected by debris, and it is possible to prevent the total positive terminal 15 and the total negative terminal 16 from being short-circuited through the wire 83 and 84.

### Embodiment 2

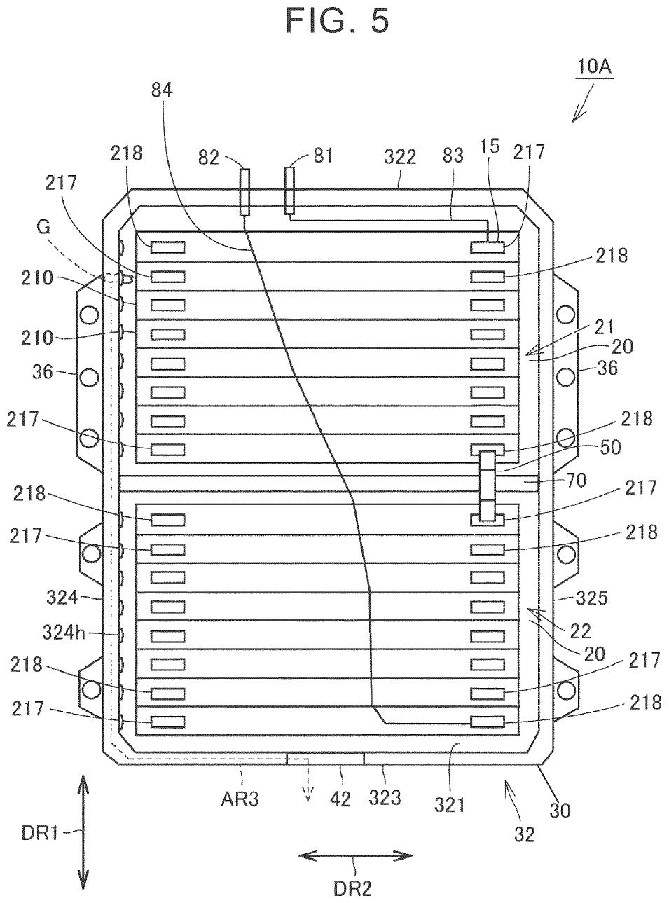

FIG. 5 is a diagram for explaining a flow of gas discharged from a power storage stack in the power storage device according to the second embodiment.

As shown in FIG. 5, in the power storage device 10A according to the second embodiment, when compared with the power storage device 10 according to the first embodiment, the housing case 30 is structurally different, and the path through which the gases flow is different. The other configurations are substantially the same.

The housing case 30 includes a side wall portion 324 as a third wall portion and a side wall portion 325 as a fourth wall portion, and the housing case 30 is provided with a plurality of inlet 324h. Specifically, the plurality of inlet 324h are provided in the side wall portion 324. Each of the plurality of inlet 324h is provided so as to face the exhaust valve 215 provided in each of the first power storage stack 21 and the second power storage stack 22 in the second direction.

In addition, the side wall portion 324 and the second wall portion 323 are provided with an exhaust flow path for connecting the case-side exhaust valve 42 from the plurality of inlet 324h. The cross member 70 may be provided in a state in which the side wall portion 324 and the side wall portion 325 are connected to each other, or may be provided in a state in which a gap is formed between the side wall portions 324, 325.

In the second embodiment, for example, when the gas G is discharged from any of the unit cells 210 of the first power storage stack 21, the gas G is introduced into the exhaust passage from the inlet 324h facing the exhaust valve 215 in the second direction, and is discharged to the outside from the case-side exhaust valve 42 through the exhaust passage as indicated by an arrow AR3 in the drawing.

Even with the configuration as described above, the power storage device 10A according to the second embodiment has substantially the same advantages as the power storage device 10 according to the first embodiment. In addition, an exhaust flow path is provided in the outer wall portion (more specifically, the side wall portion 324 and the second wall portion 323) of the housing case 30. Therefore, the accumulation of the debris contained in the gas in the accommodation space of the housing case 30 can be suppressed, and a short circuit in the first power storage stack 21 or the second power storage stack 22 caused by the debris can be suppressed.

### Embodiment 3

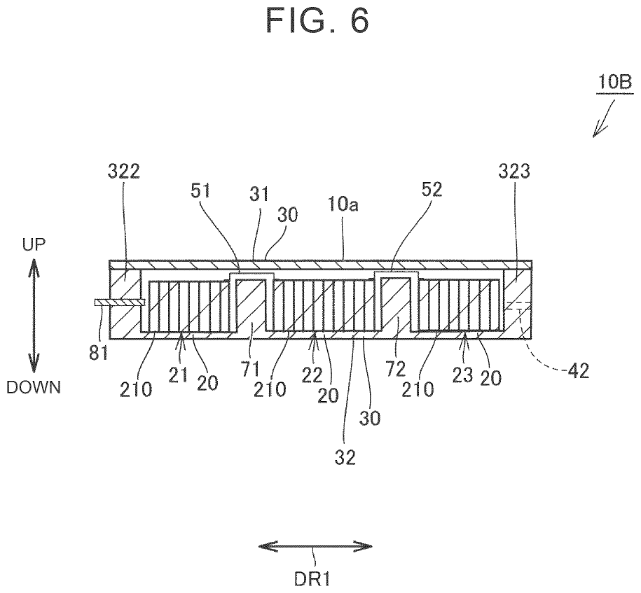

FIG. 6 is a cross-sectional view of a power storage device according to Embodiment 3. Referring to FIG. 6, a power storage device 10B according to a third embodiment will be described.

As shown in FIG. 6, the power storage device 10B according to Embodiment 3 mainly differs in the number of power storage stacks included in the power storage module 20 and the configuration of the housing case 30 when compared with the power storage device 10A according to Embodiment 1. The other configurations are substantially the same.

In the third embodiment, the power storage module 20 includes a first power storage stack 21, a second power storage stack 22, and a third power storage stack 23. The first power storage stack 21, the second power storage stack 22, and the third power storage stack 23 are arranged side by side in the first direction.

The regions in which the first power storage stack 21, the second power storage stack 22, and the third power storage stack 23 are disposed are partitioned by the cross members 71 and 72. The cross member 71 is disposed between the first power storage stack 21 and the second power storage stack 22. The cross member 72 is disposed between the second power storage stack 22 and the third power storage stack 23.

The first power storage stack 21, the second power storage stack 22, and the third power storage stack 23 are connected in series by electrical connection members 51 and 52. The electrical connection member 51 electrically connects the first power storage stack 21 and the second power storage stack 22. The electrical connection member 51 is provided across the cross member 71. The electrical connection member 52 electrically connects the second power storage stack 22 and the third power storage stack 23. The electrical connection member 52 is provided across the cross member 72.

Also in the third embodiment, the first connector 81 and the second connector 82 (not shown in FIG. 6) are provided in the first wall portion 322, and the case-side exhaust valve 42 is provided in the second wall portion 323. Further, the first power storage stack 21, the second power storage stack 22, and the third power storage stack 23 are provided so that the exhaust valves 215 face in the second direction, and are provided so as to be capable of discharging gas in the second direction. Therefore, in the power storage device 10B according to the third embodiment, substantially the same advantages as those of the power storage device 10 according to the first embodiment can be obtained.

### Other Variations

In Embodiments 1 and 2 described above, a case where two power storage stacks are arranged is illustrated as an example. However, the present disclosure is not limited to this, as long as the power storage stack is configured to be capable of discharging gas in the second direction, one power storage stack may be arranged, or a plurality of power storage stacks may be arranged in a matrix. Further, in the third embodiment described above, the number of the power storage stacks is three, but the present disclosure is not limited thereto, and may be four or more.

In Embodiments 1 to 3 described above, the exhaust valve 215 provided in each unit cell 210 of the first power storage stack 21 and the second power storage stack 22 is directed toward one side in the second direction. The plurality of unit cells 210 may be arranged in the first direction in a state in which the plurality of exhaust valves 215 provided in the first power storage stack 21 and the second power storage stack 22 are alternately positioned on one side and the other side in the second direction.

In the second embodiment described above, the exhaust valves 215 included in the first power storage stack 21 may be located on one side in the second direction, and the exhaust valves 215 included in the second power storage stack 22 may be located on the other side in the second direction. In this case, the plurality of introduction ports 324h corresponding to the respective exhaust valves 215 of the first power storage stack 21 may be provided in the side wall portion 324, and the plurality of introduction ports corresponding to the respective exhaust valves of the second power storage stack 22 may be provided in the side wall portion 325. In addition, the exhaust valves 215 included in the first power storage stack 21 and the second power storage stack 22 may be positioned on the other side in the second direction, and a plurality of introduction ports and an exhaust flow path communicating the plurality of introduction ports and the case-side exhaust valve 42 may be provided in the side wall portion 325 as the fourth wall portion.

In Embodiments 1 to 3 described above, a case has been described in which the first direction is parallel to the front-rear direction of the vehicle and the second direction is parallel to the width direction of the vehicle, but the present disclosure is not limited thereto. The first direction may be parallel to the width direction of the vehicle, and the second direction may be parallel to the front-rear direction of the vehicle.

The embodiments disclosed herein are illustrative and not restrictive in all respects. The scope of the present disclosure is defined by the claims, and includes all modifications within the meaning and range equivalent to the claims.

What is claimed is:

1. A power storage device comprising:
a power storage module including one or more power storage stacks and including a total positive terminal and a total negative terminal;
a housing case that houses the power storage module;
a case-side exhaust valve provided in the housing case; and
a first connector electrically connected to the total positive terminal and a second connector electrically connected to the total negative terminal, wherein
the housing case includes a first wall portion and a second wall portion facing each other in a first direction,
the first connector and the second connector are provided on the first wall portion,
the case-side exhaust valve is provided on the second wall portion, and
the one or more power storage stacks are each provided to discharge gas in a second direction orthogonal to the first direction.

2. The power storage device according to claim 1, wherein the gas discharged from any of the one or more power storage stacks is discharged from the case-side exhaust valve through a space in the housing case.

3. The power storage device according to claim 1, wherein:
the housing case includes a third wall portion and a fourth wall portion each connecting two ends of the first wall portion and the second wall portion in the second direction; and
at least either of the third wall portion and the fourth wall portion is provided with an inlet into which the gas is introduced, and a flow path connecting the inlet and the case-side exhaust valve.
